(19) United States
(12) Patent Application Publication
(10) Pub. No.: US 2009/0201782 A1
(43) Pub. Date: Aug. 13, 2009

(54) HOLOGRAPHIC DISK WITH OPTICAL-NOTCH-FILTER LABEL

(75) Inventors: Daniel J. Winarski, Tucson, AZ (US); Allen K. Bates, Tucson, AZ (US); Nils Haustein, Soergenloch (DE); Craig A. Klein, Tucson, AZ (US)

Correspondence Address: CARPENTER & ASSOCIATES, 5 PIPESTEM COURT, ROCKVILLE, MD, 20854, US

(73) Assignee: INTERNATIONAL BUSINESS MACHINES CORPORATION, Armonk, NY (US)

(21) Appl. No.: 12/028,009

(22) Filed: Feb. 7, 2008

(51) Int. Cl. G11B 7/00

(52) U.S. Cl. 369/103

(57) ABSTRACT

A holographic disk, including: a holographic recording layer and a servo-tracking layer, the holographic recording layer separated from the servo-tracking layer by a dichroic mirror that prevents a data I/O laser from accessing the servo-tracking layer while allowing a servo-tracking laser to access embedded servo tracks; a transparent cover layer including at least one layer of optical notch filter that forms a label, the optical notch filter blocking light at a wavelength different from the data I/O laser and the servo-tracking laser; where the label is a color label including at least one of numbers, letters, descriptive figures, pictures, and barcodes.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### THE NAMES OF THE PARTY TO A JOINT RESEARCH AGREEMENT

(Not Applicable)

### INCORPORATION-BY-REFERENCE OF MATERIAL SUBMITTED ON A COMPACT DISC

(Not Applicable)

### BACKGROUND OF THE INVENTION

(1) Field of the Invention

This disclosure is directed to a holographic disk with an optical notch filter.

(2) Description of Related Art Including Information Submitted under 37 CFR 1.97 and 1.98

Kameno et al. (U.S. Pat. No. 6,661,547) discloses a holographic recording layer and at least one layer of optical notch filter (“holographic notch filter made of a holographic recording material” (Kameno et al. column 4, lines 22-25)).

### BRIEF SUMMARY OF THE INVENTION

At least some aspects of this disclosure are directed to a holographic storage media. Other aspects of this disclosure are directed to a holographic storage media that can be formed utilizing methodologies disclosed herein. Other aspects of this disclosure are directed to methods for storing information on holographic storage media formed utilizing methodologies and/or holographic storage media structures disclosed herein.

Other aspects of this disclosure are directed to information stored on holographic storage media disclosed herein and/or formed utilizing the methodologies disclosed herein.

In particular, at least some aspects of this disclosure are directed to a holographic disk, including: a holographic recording layer and a servo-tracking layer, the holographic recording layer separated from the servo-tracking layer by a dichronic mirror that prevents a data I/O laser from accessing the servo-tracking layer while allowing a servo-tracking laser to access embedded servo tracks; a transparent cover layer including at least one layer of optical notch filter that forms a label, the optical notch filter blocking light at a wavelength different from the data I/O laser and the servo-tracking laser, where the label is a color label including at least one of numbers, letters, descriptive figures, pictures, and barcodes.

In at least some embodiments, the color label includes barcodes that can be selected from the group including at least one of parallel lines, concentric rings, and two-dimensional matrices.

In at least some embodiments, the holographic storage media can include a wavelength of the data I/O laser of about 405 nm, a wavelength of the servo-tracking laser of about 680 nm, and a wavelength of the optical notch filter selected from the group of about 442 nm, about 488 nm, about 514 nm, about 526 nm, about 594 nm, and about 633 nm.

In at least some embodiments, the wavelength of the data I/O laser can be selected from about 514 nm and about 532 nm, the wavelength of the servo-tracking laser can be about 680 nm, and the wavelength of the optical notch filter can be selected from the group of about 442 nm, about 488 nm, about 594 nm, and about 633 nm.

In at least some embodiments, the holographic media or disk can be a dual-sided disk, including holographic recording layers on each side of the servo-tracking layer.

Other exemplary embodiments and advantages of this disclosure can be ascertained by reviewing the present disclosure and the accompanying drawings.

### BRIEF DESCRIPTION OF THE SEVERAL VIEWS OF THE DRAWING(S)

This disclosure is further described in the detailed description that follows, with reference to the drawings, in which:

FIG. 1 shows a cross-section of single-layer reflective holographic media in accordance with at least some aspects of this disclosure;

FIG. 2 shows an optical notch filter centered at 514 nm in accordance with at least some aspects of this disclosure; and

FIG. 3 shows an optical notch filter centered at 526 nm in accordance with at least some aspects of this disclosure.

### DETAILED DESCRIPTION OF THE INVENTION

Exemplary embodiments of this disclosure are described herein by way of example.

Transmissive and reflective holographic disks should generally not have labels that block the lasers of the holographic drive from accessing the disks.

This disclosure addresses this issue by identifying and utilizing band-blocking layers that can be selectively applied to create color labels while allowing the data I/O laser light and servo-tracking laser light to both pass through.

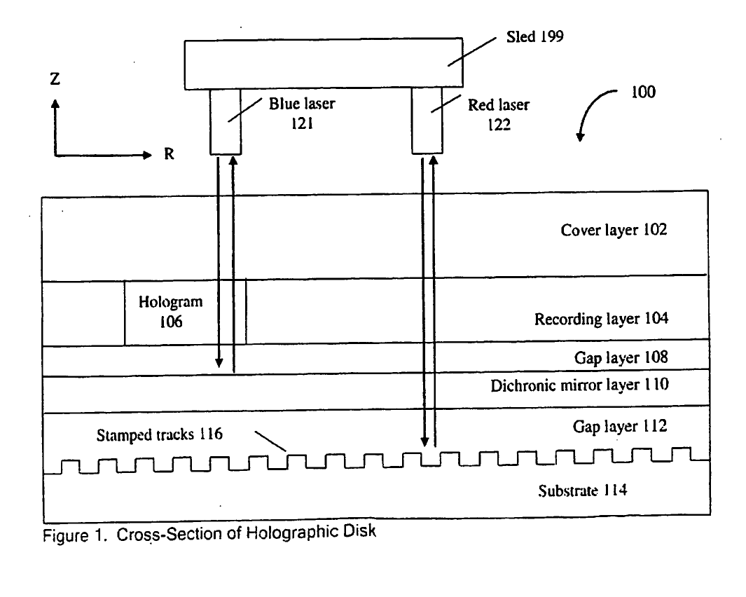

FIG. 1 shows a cross-section of single-layer reflective holographic media 100 comprising transparent cover layer 102, holographic recording layer 104, gap layer 108, dichronic mirror layer 110, gap layer 112, and tracks 116 formed in substrate 114. Tracks 116 provide lands and grooves, but alternatively tracks 116 can include a sequence of pits. Tracks 116 include either a plurality of concentric rings or a single, continuous spiral.

Hologram 106 is written and read by light from a first laser 121, which makes first laser 121 a data I/O laser, Light from first laser 121 may be either violet (405 nm) or green (514 or 532 nm) in wavelength, and it is selectively reflected by dichronic mirror layer 110, and thus does not penetrate to tracks 116 of holographic media 100. Holographic recording layer 104 is the principal, high-capacity, long-term data storage layer. Tracks 116 are used by the tracking-error-servo of the holographic disk drive to assist light from first laser 121 to read and write holograms to holographic recording layer 104.

Dichronic mirror layer 110 is selectively transparent to the wavelength of light from second (or servo-tracking) laser 122, in this case red laser light of a wavelength of 680 nm, which is the same wavelength of the common DVD (Digital Versatile Disk). Second laser 122 and first laser 121 do not have the same wavelength. However, second laser 122 and first laser 121 are on the same physical sled 199 for radial seeks along disk 100. Tracks 116 may be coated with a layer such as gold, aluminum, silver, or silicon to make it more reflective and detectable by the light from second laser 122.

Disk 100 can, in some embodiments, be dual-sided, where the obverse side is a mirror image of the layering above the layer of tracks 116.

Cover layer 102 can, in some embodiments, include one or more layers of optical notch filter materials 200 and 300 that allow the light from first (data I/O) laser 121 and light from second (servo-tracking) laser 122 to both pass through cover layer 102.

For the purposes of explaining the optical notch filters utilized in the holographic media of this disclosure, the term Optical Density (OD) is explained below.

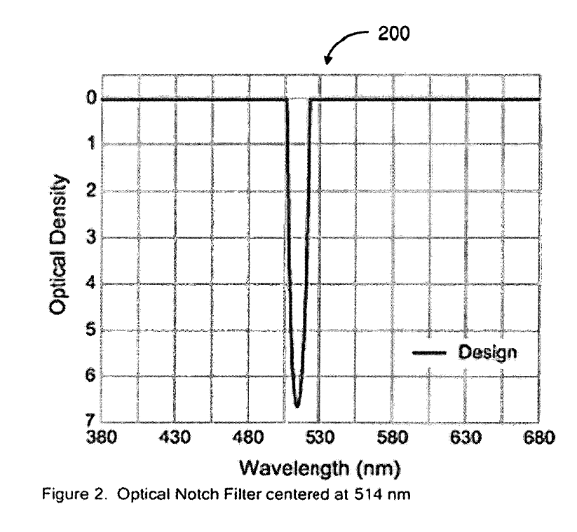

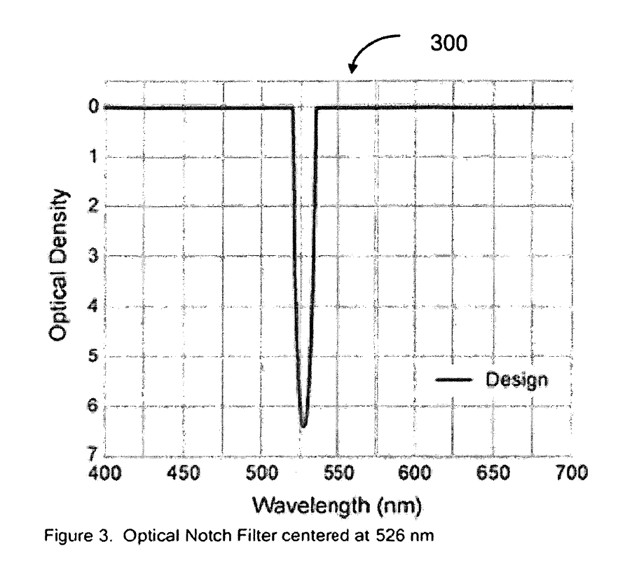

Optical Density (OD): For a given wavelength, an expression of the transmittance of an optical element. Optical density is expressed by log₁₀ (1/T) where T is transmittance. The higher the optical density, the lower the transmittance. Optical density times 10 is equal to the transmission loss expressed in decibels, e.g., an optical density of 0.3 corresponds to a transmission loss of 3 dB. If the optical transmittance is 100%, then T is 1 and log₁₀ (1/1) is zero, and that explains the zero value of optical density for the wavelength (horizontal) axis as shown in FIGS. 2 and 3. Another resource is Table 1 which associates color registered by the human eye and wavelength of light:

TABLE 1
Color (Human Eye) versus Wavelength

| Color | Wavelength in nm |
|---|---|
| Violet | 377-430 |
| Blue | 430-455 |
| Blue-Green | 455-485 |
| Green | 485-540 |
| Yellow | 540-590 |
| Orange | 590-630 |
| Red | 630-755 |

In FIGS. 2 and 3, the wavelengths blocked are 514 and 526 nm, respectively, so these optical notch filters would appear as green to the human eye when used as layers in cover layer 102.

Other materials are available, providing optical notch filtering at 442 nm (blue), 488 nm (blue-green), 594 nm (orange), and 633 nm (red).

Thus, blue, blue-green, green, orange, and red colors are available for labeling of a holographic disk, while still permitting high transmittance (optical density of zero) for first (data) laser 121 and second (servo-tracking) laser 122. These labels may be in the form of numbers, letters, descriptive figures, pictures, and barcodes. The barcodes may be parallel lines, concentric rings, and two-dimensional matrices.

Thus, the present disclosure provides optical notch filters that selectively block specific wavelengths not used for data I/O and tracking, in order to create a user-friendly label for holographic disks.

The foregoing exemplary embodiments have been provided for the purpose of explanation and are in no way to be construed as limiting this disclosure. This disclosure is not limited to the particulars disclosed herein, but extends to all embodiments within the scope of the appended claims, and any equivalents thereof.

1. A holographic disk, comprising:
a holographic recording layer and a servo-tracking layer, the holographic recording layer separated from the servo-tracking layer by a dichroic mirror that prevents a data I/O laser from accessing the servo-tracking layer while allowing a servo-tracking laser to access embedded servo tracks;
a transparent cover layer comprising more than one layer of optical holographic notch filter that forms a label, the optical holographic notch filter blocking light at a wavelength different from the data I/O laser and the servo-tracking laser, and the optical holographic notch filter allowing light from the data I/O laser and the servo-tracking laser to pass through the cover layer;
wherein the label is a color label comprising at least one of numbers, letters, descriptive figures, pictures, and barcodes; and wherein the label information is recorded holographically as part of the optical holographic notch filter.
